(19) United States
(12) Patent Application Publication
(10) Pub. No.: US 2026/0017118 A1
(43) Pub. Date: Jan. 15, 2026

(54) RESOURCE SHARING METHOD AND ASSOCIATED APPARATUS THAT CAN ACHIEVE CROSS-PLATFORM RESOURCE SHARING MECHANISM VIA SAME USER INPUT DEVICE

(71) Applicant: Realtek Semiconductor Corp., HsinChu (TW)

(72) Inventors: Ding-Wei Chen, HsinChu (TW); Yu-Pin Lin, HsinChu (TW)

(73) Assignee: Realtek Semiconductor Corp., HsinChu (TW)

(21) Appl. No.: 18/977,995

(22) Filed: Dec. 12, 2024

(30) Foreign Application Priority Data
Jul. 12, 2024 (TW) 113126229

(51) Int. Cl. G06F 9/50; G06F 3/14; G06F 9/54

(52) U.S. Cl. CPC G06F 9/5077; G06F 3/14; G06F 9/543

(57) ABSTRACT

A display device includes at least one video connection terminal, a display screen, a memory, and a processing circuit. The video connection terminal is arranged to receive at least one video source from at least one device. The display screen is arranged to display at least one divided frame corresponding to the device on an original frame corresponding to the display device. The memory is arranged to store a program code. The processing circuit is arranged to read and execute the program code from the memory, in order to share resources in the divided frame between the display device and the device according to a user input.

### BACKGROUND OF THE INVENTION

### 1. Field of the Invention

The present invention is related to resource sharing, and more particularly, to a display device that can achieve a cross-platform resource sharing mechanism via the same user input device, an associated display system, and an associated resource sharing method.

### 2. Description of the Prior Art

In the field of display devices, resources on a current display device can be shared via a user input (e.g., a copy command and a paste command) received by a user input device. Under a situation where the display device is connected to different video source devices, the resource sharing range is limited to the display device, meaning the resources on the display device cannot be shared to any connected video source device, and resources on the connected video source device cannot be shared to the display device.

As a result, a novel display device that can achieve a cross-platform resource sharing mechanism via the same user input device is urgently needed.

### SUMMARY OF THE INVENTION

It is therefore one of the objectives of the present invention to provide a display device that can achieve a cross-platform resource sharing mechanism via the same user input device, an associated display system, and an associated resource sharing method, in order to address the above-mentioned issues.

According to an embodiment of the present invention, a display device is provided. The display device comprises at least one video connection terminal, a display screen, a memory, and a processing circuit. The at least one video connection terminal is arranged to receive at least one video source from at least one device. The display device is arranged to display at least one divided frame corresponding to the at least one device on an original frame corresponding to the display device. The memory is arranged to store a program code. The processing circuit is arranged to read and execute the program code from the memory in order to share resources in the at least one divided frame between the display device and the at least one device according to a user input.

According to an embodiment of the present invention, a resource sharing method is provided. The resource sharing method comprises: receiving at least one video source from at least one device; displaying at least one divided frame corresponding to the at least one device on an original frame corresponding to a display device; and sharing resources in the at least one divided frame between the display device and the at least one device according to a user input.

According to an embodiment of the present invention, a display system is provided. The display system comprises a display device and a user input device. The display device is arranged to receive at least one video source from at least one device, and comprises a display screen. The display screen is arranged to display at least one divided frame corresponding to the at least one device on an original frame corresponding to the display device. The user input device is coupled to the display device, and is arranged to receive a user input, wherein resources in the at least one divided frame are shared between the display device and the at least one device according to the user input.

One of the benefits of the present invention is that the display device can quickly achieve resource sharing between the display device and video source devices via a user input received by the same user input device. In addition, the display device of the present invention can display a list on a display screen for a user to perform a selection operation upon multiple resources corresponding to multiple copy commands according to the list, in order to generate a selection result for performing subsequent paste commands and completing the resource sharing. In this way, the problem of unclear resources to be shared can be solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display system according to an embodiment of the present invention.

FIG. 2 is a diagram illustrating sharing a resource of a video source device to another video source device via a user input according to an embodiment of the present invention.

FIG. 3 is a diagram illustrating sharing a resource of a video source device to another video source device via a list and a user input under a situation where multiple copy commands are input according to an embodiment of the present invention.

FIG. 4 is a flow chart of a resource sharing method according to an embodiment of the present invention.

### DETAILED DESCRIPTION

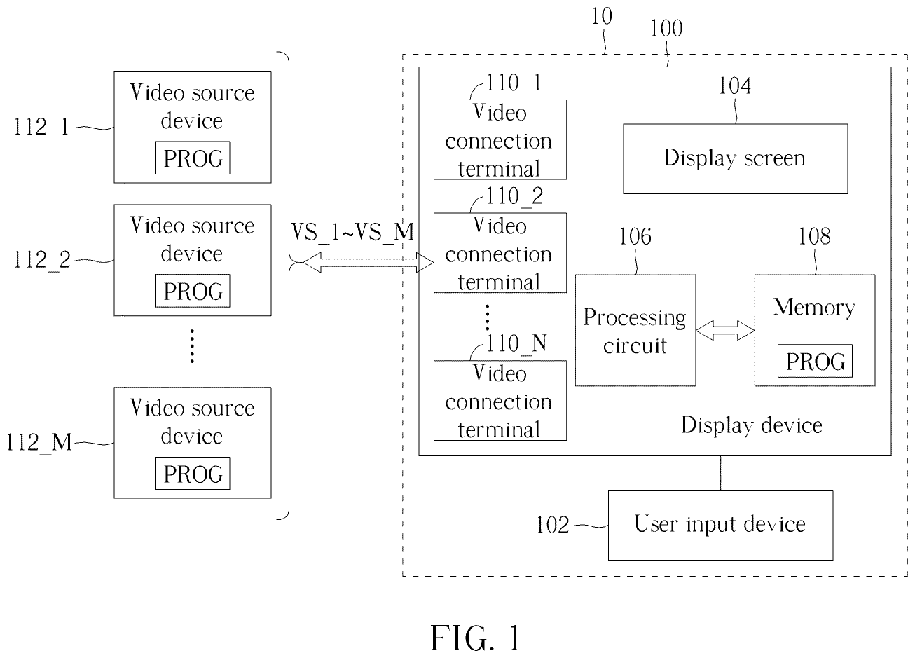

FIG. 1 is a diagram illustrating a display system 10 according to an embodiment of the present invention. As shown in FIG. 1, the display system 10 may include a display device 100 and a user input device 102. The display device 100 may include a display screen 104, a processing circuit 106, a memory 108, and at least one video connection terminal (e.g., multiple video connection terminals 110_1-110_N), wherein “N” is a positive integer greater than one. Examples of the video connection terminals 110_1-110_N may include, but are not limited to: High Definition Multimedia Interface (HDMI), DisplayPort (DP), Universal Serial Bus (USB) Type-C, and other types of video transmission interfaces. The display device 100 may be connected to at least one video source device via the video connection terminals 110_1-110_N, in order to receive at least one video source from the at least one video source device for displaying on the display screen 104. In this embodiment, the display device 100 may be connected to multiple video source devices 112_1-112_M, and receive multiple video sources VS_1-VS_M from the video source devices 112_1-112_M, respectively, wherein “M” is a positive integer greater than one. For example, each of the video source devices 112_1-112_M may be one of a multifunctional mobile phone, a tablet computer, a personal computer (e.g., a desktop computer and a laptop computer), a set-top box (STB), a game console, a multimedia player, a Digital Versatile Disc (DVD) player, or a Blu-ray Disc (BD) player. In some embodiments, the display device 100 may be connected to the video source devices 112_1-112_M by a wireless means. For example, the display device 100 may receive the video sources VS_1-VS_M from the video source devices 112_1-112_M based on the wireless projection conforming to the Miracast protocol specified by the Wi-Fi Alliance.

After the video sources VS_1-VS_M are received, the display screen 104 may be arranged to display multiple divided frames respectively corresponding to the video source devices 112_1-112_M on an original frame corresponding to the display device 100 (i.e., the multiple divided frames may display the video sources VS_1-VS_M received from the video source devices 112_1-112_M, respectively). The user input device 102 may be coupled to the display device 100, and may be arranged to receive a user input USER_IN, wherein resources in the multiple divided frames can be shared between the display device 100 and the video source devices 112_1-112_M according to the user input USER_IN, the resources may be pictures, texts, or files in the multiple divided frames, the user input USER_IN may include copy commands and paste commands, and the user input device 102 may be a keyboard or a mouse, but the present invention is not limited thereto. Specifically, program code PROG may be pre-programmed in the memory 108, and the processing circuit 106 may read and execute the program code PROG from the memory 108 to implement the resource sharing method proposed by the present invention. Similarly, each video source device among the video source devices 112_1-112_M may read and execute the program code PROG stored in a memory to implement the resource sharing method. In addition, each device among the display device 100 and the video source devices 112_1-112_M may include a temporary storage region for temporarily storing resources during resource sharing, and may have an application programming interface (API) for accessing data in the temporary storage region.

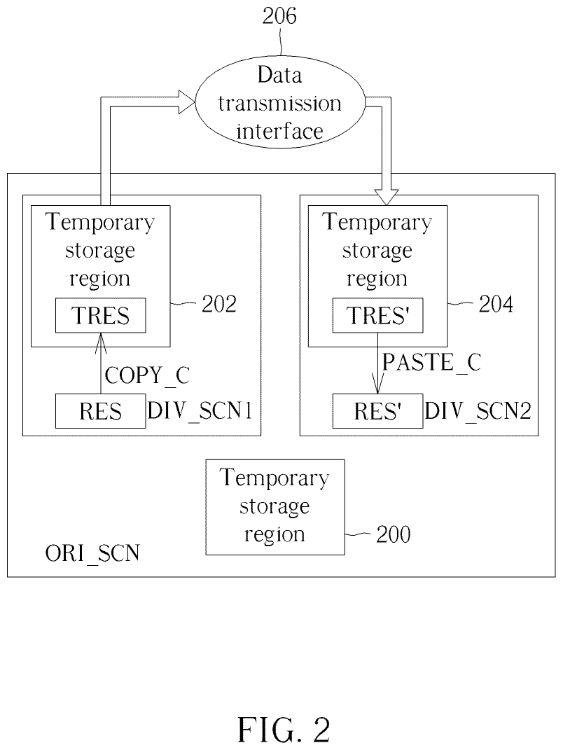

FIG. 2 is a diagram illustrating sharing a resource RES of a video source device S_1 to a video source device S_2 via the user input USER_IN according to an embodiment of the present invention, wherein the video source device S_1 may be one of the video source devices 112_1-112_M shown in FIG. 1, the video source device S_2 may be another of the video source devices 112_1-112_M, and the display screen 104 may be arranged to display a divided frame DIV_SCN1 corresponding to the video source device S_1 and a divided frame DIV_SCN2 corresponding to video source device S_2 on an original frame ORI_SCN corresponding to the display device 100. Each of the display device 100, the video source device S_1, and the video source device S_2 includes a temporary storage region for temporarily storing data (e.g., a temporary storage region 200 corresponding to the display device 100, a temporary storage region 202 corresponding to the video source device S_1, and a temporary storage region 204 corresponding to the video source device S_2). For better comprehension, in FIG. 2, respective temporary storage regions are shown in corresponding frames of each device in order to clearly indicate the transmission direction of the resources. In practice, these temporary storage regions will not displayed on the display screen 104.

In the beginning, a user may input (e.g., press) a copy command COPY_C regarding resources to be shared (e.g., the resource RES in the divided frame DIV_SCN1, such as pictures, texts, or files in the divided frame DIV_SCN1) via the user input device 102. In response to the copy command COPY_C, the resource RES may be copied to the temporary storage region 202 for acting as a temporary storage resource TRES. It should be noted that, when the user input device 102 receives the copy command COPY_C, the processing circuit 106 may execute the program code PROG to establish a data transmission interface 206, in order to transmit the temporary storage resource TRES to a temporary storage region of a destination device via the data transmission interface 206 in response to a subsequent user input USER_IN, wherein examples of the data transmission interface 206 may include but are not limited thereto: bluetooth (BT), Wi-Fi, and internet.

Afterwards, the user may input (e.g., press) a paste command PASTE_C regarding a divided frame corresponding to the destination device (e.g., the divided frame DIV_SCN2 corresponding to the video source device S_2). The paste command PASTE_C may indicate to transmit the temporary storage resource TRES to the temporary storage region 204 corresponding to the video source device S_2 via the data transmission interface 206 for acting as a temporary storage resource TRES′, and may indicate to paste the temporary storage resource TRES′ on the divided frame DIV_SCN2 as a resource RES′, wherein the resource RES' is a copied version of the resource RES. After the paste command PASTE_C is completed, the data transmission interface 206 between the video source devices S_1 and S_2 can be disconnected. In this embodiment, resource sharing is performed between the video source devices S_1 and S_2, but the present invention is not limited thereto. In some embodiments, resources of the display device 100 may be shared to the video source device, or resources of the video source device may be shared to the display device 100. In some embodiments, resource sharing may be performed among more than two video source devices. These alternative designs all fall within the scope of the present invention. For brevity, similar descriptions for these embodiments are not repeated in detail here.

Under some situations, the user may continually input multiple copy commands regarding different divided frames before the paste command regarding the divided frame of the destination device is input, which may cause the problem of unclear resources to be shared. In order to address this issue, respective temporary storage regions included in the display device 100 and the video source devices 112_1-112_M may include a list for recording information associated with the temporary storage resource, in order for the user to perform a selection operation.

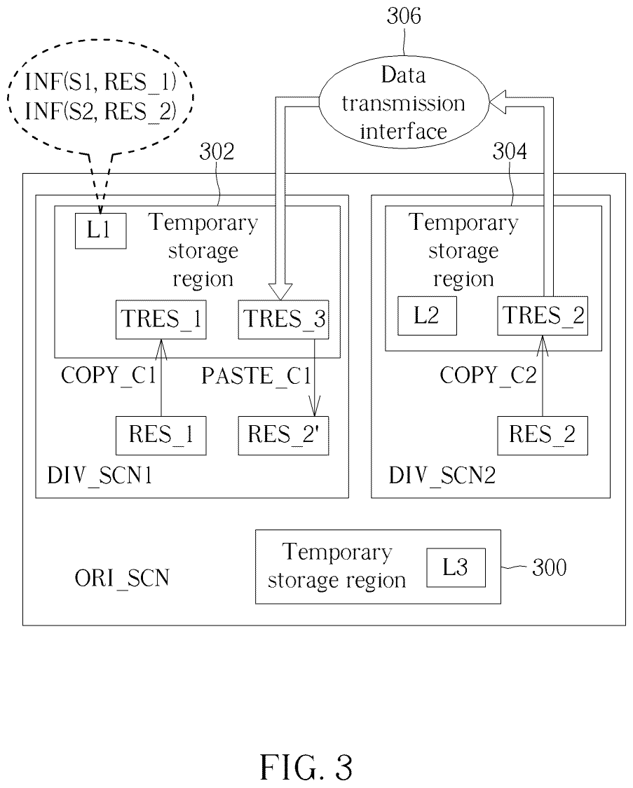

FIG. 3 is a diagram illustrating sharing the resource of the video source device S_2 to the video source device S_1 via a list and the user input USER_IN under a situation where multiple copy commands COPY_C1 and COPY_C2 are input according to an embodiment of the present invention, wherein the video source device S_1 may be one of the video source devices 112_1-112_M shown in FIG. 1, the video source device S_2 may be another of the video source devices 112_1-112_M, and the display screen 104 may be arranged to display a divided frame DIV_SCN1 corresponding to the video source device S_1 and a divided frame DIV_SCN2 corresponding to video source device S_2 on an original frame ORI_SCN corresponding to the display device 100. Each of the display device 100, the video source device S_1, and the video source device S_2 includes a temporary storage region for temporarily storing data (e.g., a temporary storage region 300 corresponding to the display device 100, a temporary storage region 302 corresponding to the video source device S_1, and a temporary storage region 304 corresponding to the video source device S_2), wherein the temporary storage regions 300, 302, and 304 may include lists L3, L1, and L2, respectively. For better comprehension, in FIG. 3, respective temporary storage regions are shown in corresponding frames of each device in order to clearly indicate the transmission direction of the resources. In practice, these temporary storage regions will not displayed on the display screen 104.

For a list among the lists L1, L2, and L3, after a resource is copied to a corresponding temporary storage region as a temporary storage resource in response to a copy command, information associated with the temporary storage resource may be recorded in the list, and the list may be synchronized with the remaining lists among the lists L1, L2, and L3 for displaying on the display screen 104, wherein the information associated with the temporary storage resource may include a corresponding resource and a corresponding device. In this way, the user may perform a selection operation upon multiple information recorded in the list, in order to determine a target resource and thereby address problems of unclear resources to be shared.

In detail, the user may input (e.g., press) a copy command COPY_C1 regarding a resource RES_1 in the divided frame DIV_SCN1 via the user input device 102. In response to the copy command COPY_C1, the resource RES_1 may be copied to the temporary storage region 302 as a temporary storage resource TRES_1. Information associated with the temporary storage resource TRES_1 (which includes a corresponding device (e.g., the video source device S_1) and a corresponding resource (e.g., the resource RES_1); for brevity, labeled as “INF(S1, RES_1)”) may be recorded in the list L1, and the list L1 may be synchronized with the lists L2 and L3 (i.e., both the lists L2 and L3 will record the information INF(S1, RES_1)). It should be noted that, when the user input device 102 receives the copy command COPY_C1, the processing circuit 106 may execute the program code PROG to establish a data transmission interface 306, in order to transmit the temporary storage resource TRES_1 or temporary storage resources corresponding to subsequent copy commands to a temporary storage region of a destination device via the data transmission interface 306 in response to a subsequent user input USER_IN.

Afterwards, the user may input (e.g., press) another copy command COPY_C2 regarding a resource RES 2 in the divided frame DIV_SCN2 via the user input device 102. In response to the copy command COPY_C2, the resource RES_2 may be copied to the temporary storage region 304 as a temporary storage resource TRES 2. Information associated with the temporary storage resource TRES 2 (which includes a corresponding device (e.g., the video source device S_2) and a corresponding resource (e.g., the resource RES_2); for brevity, labeled as “INF(S2, RES_2)”) may be recorded in the list L2, and the list L2 may be synchronized with the lists L1 and L3 (i.e., both the lists L1 and L3 will record the information INF(S1, RES_1) and the information INF(S2, RES_2)). The user then inputs (e.g., presses) a paste command PASTE_C1 regarding the divided frame DIV_SCN1 corresponding to the video source device S_1. At this moment, the display screen 104 may be further arranged to display the list L1 corresponding to the divided frame DIV_SCN1 in order for a user to perform a selection operation upon the temporary storage resources TRES_1 and TRES 2 according to the information INF(S1, RES_1) and the information INF(S2, RES_2), for generating a selection result SEL_R as the target resource pasted on the divided frame DIV_SCN1.

For example, in response to the selection result SEL_R being the temporary storage resource TRES_2, the temporary storage resource TRES 2 may be transmitted to the temporary storage region 302 as a temporary storage resource TRES 3 via the data transmission interface 306, and the temporary storage resource TRES 3 may be pasted on the divided frame DIV_SCN1 as a resource RES_2′, wherein the resource RES_2′ is a copied version of the resource RES_2. In another example, in response to the selection result SEL_R being the temporary storage resource TRES_1, the temporary storage resource TRES_1 may be accessed from the temporary storage region 302, and may be directly pasted on the divided frame DIV_SCN1 as the resource RES_2′.

After the paste command PASTE_C1 is completed, the data transmission interface 306 between the video source devices S_1 and S_2 may be disconnected. In this embodiment, resource sharing is performed between the video source devices S_1 and S_2 by the user input USER_IN and the list, but the present invention is not limited thereto. In some embodiments, resources of the display device 100 may be shared to the video source device by the user input USER_IN and the list, or resources of the video source device may be shared to the display device 100 by the user input USER_IN and the list. In some embodiments, resource sharing may be performed among more than two video source devices by the user input USER_IN and the list. These alternative designs all fall within the scope of the present invention. For brevity, similar descriptions for these embodiments are not repeated in detail here.

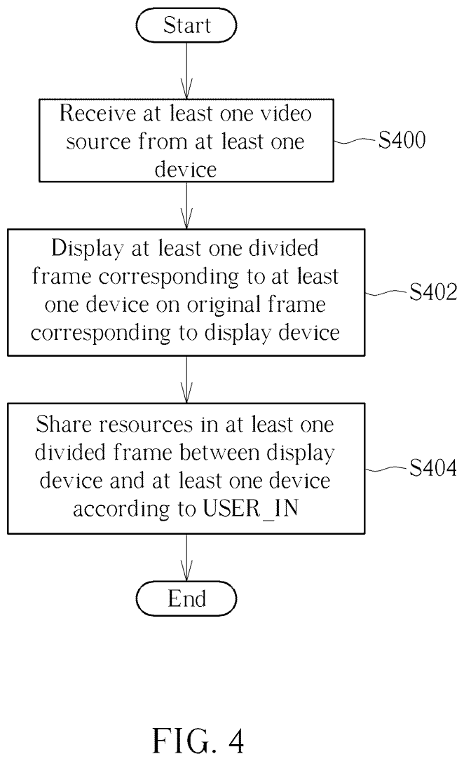

FIG. 4 is a flow chart of a resource sharing method according to an embodiment of the present invention. Provided that the result is substantially the same, the steps are not required to be executed in the exact order shown in FIG. 4. The resource sharing method shown in FIG. 4 may be employed by the display device 100 (more particularly, the processing circuit 106 executing the program code PROG) shown in FIG. 1.

In Step S400, the display device 100 receives at least one video source from at least one device.

In Step S402, at least one divided frame corresponding to the at least one device is displayed on an original frame corresponding to the display device 100.

In Step S404, resources in the at least one divided frame are shared between the display device 100 and the at least one device according to the user input USER_IN.

Since a person skilled in the pertinent art can readily understand details of the steps after reading the above paragraphs directed to the processing circuit 106 shown in FIG. 1, further description is omitted here for brevity.

In summary, the display device of the present invention can quickly achieve resource sharing between the display device and video source devices via a user input received by the same user input device. In addition, the display device of the present invention can display a list on a display screen for a user to perform a selection operation upon multiple resources corresponding to multiple copy commands according to the list, in order to generate a selection result for performing subsequent paste commands and completing the resource sharing. In this way, the problem of unclear resources to be shared can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device, comprising:
at least one video connection terminal, arranged to receive at least one video source from at least one device;
a display screen, arranged to display at least one divided frame corresponding to the at least one device on an original frame corresponding to the display device;
a memory, arranged to store a program code; and
a processing circuit, arranged to read and execute the program code from the memory, in order to share resources in the at least one divided frame between the display device and the at least one device according to a user input.

2. The display device of claim 1, wherein a first device among the at least one device and the display device comprises a first temporary storage region, the user input comprises a first copy command, and the first copy command indicates to copy a resource in a first divided frame corresponding to the first device to the first temporary storage region for acting as a first temporary storage resource.

3. The display device of claim 2, wherein a second device among the at least one device and the display device comprises a second temporary storage region, the user input further comprises a paste command, and the paste command indicates to transmit the first temporary storage resource to the second temporary storage region via a data transmission interface for acting as a second temporary storage resource, and indicates to paste the second temporary storage resource on a second divided frame corresponding to the second device.

4. The display device of claim 2, wherein a second device among the at least one device and the display device comprises a second temporary storage region, the user input further comprises a second copy command, and the second copy command indicates to copy a resource in a second divided frame corresponding to the second device to the second temporary storage region for acting as a second temporary storage resource.

5. The display device of claim 4, wherein multiple temporary storage regions that respectively correspond to the at least one device and the display device comprise multiple lists; the first temporary storage region comprises a first list, first information associated with the first temporary storage resource is recorded in the first list, and the first list is synchronized with remaining lists in the multiple lists; and the second temporary storage region comprises a second list, second information related to the second temporary storage resource is recorded in the second list, and the second list is synchronized with the remaining lists in the multiple lists.

6. The display device of claim 5, wherein the user input further comprises a paste command corresponding to the first divided frame, and in response to the paste command, the display screen is further arranged to display the first list in order for a user to perform a selection operation upon the first temporary storage resource and the second temporary storage resource according to the first information and the second information, in order to generate a selection result for pasting on the first divided frame.

7. The display device of claim 6, wherein in response to the selection result being the second temporary storage resource, the second temporary storage resource is transmitted to the first temporary storage region via a data transmission interface for acting as a third temporary storage resource, and the third temporary storage resource is pasted on the first divided frame.

8. The display device of claim 6, wherein in response to the selection result being the first temporary storage resource, the first temporary storage resource is directly pasted on the first divided frame.

9. A resource sharing method, comprising:
receiving at least one video source from at least one device;
displaying at least one divided frame corresponding to the at least one device on an original frame corresponding to a display device; and
sharing resources in the at least one divided frame between the display device and the at least one device according to a user input.

10. The resource sharing method of claim 9, wherein a first device among the at least one device and the display device comprises a first temporary storage region, the user input comprises a first copy command, and the step of sharing the resources in the at least one divided frame between the display device and the at least one device according to the user input comprises:
in response to the first copy command, copying a resource in a first divided frame corresponding to the first device to the first temporary storage region for acting as a first temporary storage resource.

11. The resource sharing method of claim 10, wherein a second device among the at least one device and the display device comprises a second temporary storage region, the user input further comprises a paste command, and the step of sharing the resources in the at least one divided frame between the display device and the at least one device according to the user input further comprises:
in response to the paste command, transmitting the first temporary storage resource to the second temporary storage region via a data transmission interface for acting as a second temporary storage resource, and pasting the second temporary storage resource on a second divided frame corresponding to the second device.

12. The resource sharing method of claim 10, wherein a second device among the at least one device and the display device comprises a second temporary storage region, the user input further comprises a second copy command, and the step of sharing the resources in the at least one divided frame between the display device and the at least one device according to the user input further comprises:
in response to the second copy command, copying a resource in a second divided frame corresponding to the second device to the second temporary storage region for acting as a second temporary storage resource.

13. The resource sharing method of claim 12, wherein multiple temporary storage regions that respectively correspond to the at least one device and the display device comprise multiple lists, the first temporary storage region comprises a first list, the second temporary storage region comprises a second list, and the step of sharing the resources in the at least one divided frame between the display device and the at least one device according to the user input further comprises:
recording first information associated with the first temporary storage resource in the first list, and synchronizing the first list with remaining lists in the multiple lists; and
recording second information related to the second temporary storage resource in the second list, and synchronizing the second list with the remaining lists in the multiple lists.

14. The resource sharing method of claim 13, wherein the user input further comprises a paste command corresponding to the first divided frame, and the step of sharing the resources in the at least one divided frame between the display device and the at least one device according to the user input further comprises:
in response to the paste command, displaying the first list on a display screen in order for a user to perform a selection operation upon the first temporary storage resource and the second temporary storage resource according to the first information and the second information, in order to generate a selection result for pasting on the first divided frame.

15. The resource sharing method of claim 14, wherein the step of displaying the first list on the display screen in response to the paste command in order for the user to perform the selection operation upon the first temporary storage resource and the second temporary storage resource according to the first information and the second information, in order to generate the selection result for pasting on the first divided frame comprises:
in response to the selection result being the second temporary storage resource, transmitting the second temporary storage resource to the first temporary storage region via a data transmission interface for acting as a third temporary storage resource, and pasting the third temporary storage resource on the first divided frame.

16. The resource sharing method of claim 14, wherein the step of displaying the first list on the display screen in response to the paste command in order for the user to perform the selection operation upon the first temporary storage resource and the second temporary storage resource according to the first information and the second information, in order to generate the selection result for pasting on the first divided frame comprises:
in response to the selection result being the first temporary storage resource, directly pasting the first temporary storage resource on the first divided frame.

17. A display system, comprising:
a display device, arranged to receive at least one video source from at least one device, and comprising:
a display screen, arranged to display at least one divided frame corresponding to the at least one device on an original frame corresponding to the display device; and
a user input device, coupled to the display device, and arranged to receive a user input, wherein resources in the at least one divided frame are shared between the display device and the at least one device according to the user input.

18. The display system of claim 17, wherein the user input device is a keyboard or a mouse.
